(19) United States
(12) Patent Application Publication
(10) Pub. No.: US 2015/0007351 A1
(43) Pub. Date: Jan. 1, 2015

(54) Mobile Messaging Enhanced with Concealable and Selectively Revealable Text, Image, and Video Messages

(71) Applicants: Maher Janajri, Warren, NJ (US); Hani Shabsigh, Wayne, NJ (US); Emerson McIntyre, Brooklyn, NY (US)

(72) Inventors: Maher Janajri, Warren, NJ (US); Hani Shabsigh, Wayne, NJ (US); Emerson McIntyre, Brooklyn, NY (US)

(21) Appl. No.: 14/318,145

(22) Filed: Jun. 27, 2014

Related U.S. Application Data
(60) Provisional application No. 61/839,900, filed on Jun. 27, 2013.

(51) Int. Cl. H04L 29/06; G06F 3/0488; H04L 12/58

(52) U.S. Cl. CPC H04L 63/04; H04L 51/00; G06F 3/0488
USPC 726/30

(57) ABSTRACT

A system and method for concealing and selectively revealing mobile messages is disclosed in which a sender generates a message, such as a text message, an image, or a video. Before being sent, the message is converted into a masked message object by a message masking function, such as a redacting function. The masked message object is transmitted to a recipient. On first being displayed, the message is not readable or viewable, because it is incorporated in a masked message object. The recipient can, however, interact with a touch screen associated with their mobile messaging device. When the recipient touches the screen in a vicinity of the masked message object, all or part of the original text message, image, or video is then displayed in readable or viewable form. Methods are provided to enable a sender of a message to edit or delete the message after it has been sent,

### CROSS-REFERENCES TO RELATED APPLICATIONS

This application claims priority to U.S. provisional application 61/839,900, entitled “Selectively Concealed and Revealed Text, Image and Video Communication”, filed Jun. 27, 2013, the entire contents of which is herein incorporated by reference.

### FIELD OF THE INVENTION

The invention relates to mobile messaging, and more particularly to display control of mobile messaging so as to ensure privacy.

### BACKGROUND OF THE INVENTION

Over-the-top (OTT) mobile messaging services and messaging apps, such as WhatsApp® and Apple's iMessage®, enable mobile messaging via an internet connection rather than over a wireless network, which is used for standard SMS texting. Providers of wireless networks include: AT&T®, Verizon®, and Sprint®. Usage of OTT mobile messaging has already surpassed usage of SMS texting, largely due to the increasing use of smartphones that have mobile internet access. Other examples of OTT mobile messaging include WeChat®, Facebook® Messenger, Skype®, Kik™, GroupMe®, MessageMe™, and Snapchat®. Desktop, laptop, notebook, and tablet computers having a touch display can also run desktop versions of these smart-phone-based mobile messaging apps.

Texting (and sending images and/or videos along with text) has become the primary mode in which mobile electronic devices are being used to communicate. One advantage of texting vs talking on a smartphone is that texting is more private than talking, and so texting can be performed more discretely in situations where other people are nearby, such as in meetings.

However, a disadvantage of existing text messaging services is that the text messages can be read by people situated nearby, e.g., by people sitting next to you, or by people “looking over your shoulder”.

Another disadvantage of existing text messaging services is that the text messages (and/or images and/or videos) are typically stored on the communications device and/or on data servers, even after a message has been read and “deleted”. Thus, privacy can be breached even when the intent was to delete the message, thereby creating a mistaken expectation that the message can no longer be read.

US Patent Application 20080016575 published by Michael T. Vincent et al. on Jan. 17, 2008 entitled “Method and System of Auto Message Deletion Using Expiration” that describes a method and system of message handling that includes tagging a message with an expiration period. The message is deleted from the server after the expiration period if no third party recipient is designated or if the message is a lower priority message. The message is delivered after the expiration period to a third party if a third party recipient is designated. The method can further include sending a notification to a sender that the expiration period has been reached if the message has not been sent and optionally offering an option to the sender to either delete the message from the server or to resend it with a new or no expiration period. The message can be a text message, voice mail, or calendar event message.

U S Patent Application 20110202598 published by Jeffrey Evans et al. on Aug. 18, 2011 entitled “Messaging System Apparatuses Circuits and Methods of Operation Thereof” that describes a messaging system, apparatuses circuits and methods of operation thereof. A messaging client device is adapted to receive an impermanent message and to manage the received message in accordance with a message management policy associated with the message. An impermanent messaging server is adapted to validate said messaging client device as complying with message management policies prior to authorizing transmission of the message to said messaging client device.

US Patent Application 20060294599 published by Wong Hoo Sim et al. on Dec. 28, 2006 entitled “Method and apparatus for protecting private information on a user apparatus” that describes an apparatus having a user interface for displaying a plurality of items. The apparatus is arranged: a) to receive at least one instruction, by which instruction or instructions, one or more of a plurality of items initially displayed on the user interface is or are categorized as an item or items to be hidden and the remaining one or more of the plurality of items initially displayed on the user interface is or are categorized as an item or items to be displayed; b) to receive an instruction to hide, from the user interface, the one or more items to be hidden; and c) to hide from the user interface, the one or more items to be hidden, such that the item or items categorized as items to be displayed are displayed on the user interface, and the item or items categorized as items to be hidden are not displayed on the user interface. In one preferred arrangement, the apparatus is an electronic device. There is also provided a method for hiding one or more items of a plurality of items displayed on a user interface for a user apparatus. Again, the user apparatus may be an electronic device. There is further provided a method for selecting a new password or entering a predetermined password on a user apparatus. The user apparatus may be an electronic device for storing electronic files.

U.S. Pat. No. 7,877,781 issued to Lim on Jan. 25, 2011 entitled “Enforcing universal access control in an information management system” that describes a method and apparatus for controlling document access and application usage using centrally managed rules. The rules are stored and manipulated in a central rule database via a rule server. Policy enforcers are installed on client systems and/or on servers and perform document access and application usage control for both direct user document accesses and application usage, and application program document accesses by evaluating the rules sent to the policy enforcer. The rule server decides which rules are required by each policy enforcer. A policy enforcer can also perform obligation and remediation operations as a part of rule evaluation. Policy enforcers on client systems and servers can operate autonomously, evaluating policies that have been received, when communications have been discontinued with the rule server.

### SUMMARY OF THE INVENTION

These disadvantages in existing texting and image-sending systems are overcome by the invention. According to the invention, text messages are made unreadable or unintelligible, and the images or videos are made un-viewable or unrecognizable, until a viewer touches a touch screen display for displaying the text and/or image and/or video.

The invention also provides a system that implements universal deletion, i.e., when a user deletes a message, all instances of that message are deleted regardless of where they are stored. In one embodiment, all instances are deleted by over-writing any memory used in storing the message with random data or with quasi-random data.

The invention is an Over The Top (OTT) mobile messaging app that manages personal messaging so as to increase privacy both while using messaging, and after using messaging.

Privacy is increased while using messaging by providing a mobile messaging user with a capability of concealing (also called “masking”) the contents of a message under redaction-style bars. In one embodiment, the concealment is actuated when the user shakes their smart phone, such as to quickly conceal the message from someone who just walked up close, or someone who surprised the user by looking over the user's shoulder. Messages thereby concealed can then be viewed selectively and individually by touching one's finger to the screen (or swiping across the screen) to reveal some or all of the messages.

A system and method for concealed and selectively revealed text, image and video communication between mobile messaging devices is claimed.

In a preferred embodiment, a sender generates a text message, image, or video on a first mobile messaging device. When the sender is ready to send the message, image, or video, they may do so by, for instance, using the “send” button. This action then causes a software module operative on their mobile messaging device to automatically create a masked message object. The masked message object can, for instance, be the text message, or the image, or the video, augmented using a display masking function. The display masking function can, for example, be an action performed on the text message, image, or video such as, but not limited to, blurring, visual encryption, redacting, replacing characters, coloring, jumbling, replacing message, image or video with a random object, animating, picture replacement, or some combination thereof.

In a preferred embodiment, the text message can, for example, first be visually rearranged, and may then be redacted by effectively causing the hashed or scrambled text message to be blacked out when displayed. An image can be replaced with a generic masked object indicator.

The masked message object can then be transmitted from the first messaging device to a second messaging device via a suitable digital communications network.

A recipient can then receive and display the masked message object on their messaging device. On first being displayed, the text message may not be readable, or the image or video may not viewable, because it is incorporated in the masked message object. By touching the touchscreen of their messaging device, the recipient can cause a software module operative on their messaging device so as to render all or part of the masked message object readable as a text message, and/or to render all or part of the image or video viewable as a static or dynamic image. In a preferred embodiment, the messaging device can have a touchscreen, and the recipient can touch the screen in a vicinity of where the masked message is being displayed. This touch makes the text message readable. In some embodiments, this readable display only persists for a predetermined number of seconds, such as an interval of time deemed necessary to read the text.

The recipient can also delete the text message, the image, the video, or the blocked text object, by a simple touch of the touchscreen of the messaging device. In a preferred embodiment, the recipient can use a horizontal swipe across the touch screen in a vicinity of the text desired to be removed. Removal of the text message can remove all instances of the text message and/or image and/or video on all communications devices involved in the transaction, including any communications servers that may have participated.

In a further preferred embodiment of the invention, when a recipient has received a plurality of masked message objects, the recipient can preview the messages by an action such as, but not limited to, a vertical swipe on the touch screen in a vicinity of the masked message objects. Such an action can cause keywords of each of the masked message objects to be displayed in readable form. This display in readable form can be visible for only a short time, or can occur in sequence, with a second keyword not being displayed until a first keyword automatically turns off.

In a preferred embodiment, the masked message object may be encrypted by a suitable algorithm such as, but not limited to, a public/private key algorithm, before being transmitted. In such a system, the second messaging device may then decrypt the masked message object before displaying it.

The sender may also determine a length of time after receipt of, or opening of, the message that may lapse before the masked message object is automatically deleted from the second messaging device.

A general aspect of the invention is a method for providing enhanced message privacy when exchanging messages using a messaging device having a touchscreen. The method includes: receiving a masked message object on a messaging device, the masked message object including a message and a message masking function; displaying the masked message object on the messaging device, the message of the masked message object being unreadable or unviewable due to the message masking function; and revealing at least a part of the message so that the part of the message becomes readable or viewable in response to a touchscreen of the messaging device being touched.

In some embodiments, revealing at least a part of the message includes: touching the touchscreen of the messaging device in a region associated with part of the message to be revealed.

In some embodiments, the method further includes: deleting at least a part of the displayed message by touching the touchscreen in a region associated with the part of the message to be deleted.

In some embodiments, touching the touchscreen includes horizontally swiping the touch screen in a region associated with the message to be revealed.

In some embodiments, the message masking function includes a capability of performing at least one of the functions selected from the group consisting of: blurring, redacting, replacing characters, coloring, jumbling, animating, picture replacement, replacing the masked message object with another object.

In some embodiments, the message can include at least one of: a text message, an image, a video.

Another general aspect of the invention is a method for providing enhanced message privacy when exchanging messages using a messaging device having a touchscreen, where the method includes: generating a message on a messaging device; automatically creating a masked message object including the message and a message masking function; and sending the masked message object from the messaging device to a recipient messaging device.

In some embodiments, the message masking function includes a capability of performing at least one of the functions selected from the group consisting of: blurring, redacting, replacing characters, coloring, jumbling, animating, picture replacement.

In some embodiments, the message masking function includes: redacting at least part of the message.

Yet another general aspect of the invention is a method for providing enhanced message privacy when exchanging messages using a messaging device having a touchscreen, this method including: generating a message on a sending messaging device; automatically creating a masked message object including the message and a message masking function; sending the masked message object from the sending messaging device to a recipient messaging device; receiving the masked message object on the recipient messaging device, the object including a message and a message masking function; displaying the masked message object on the recipient messaging device, the message of the masked message object being unreadable or unviewable due to the message masking function; and revealing at least a part of the message so that the part of the message becomes readable or viewable in response to a touchscreen of the recipient messaging device being touched.

In some embodiments, the masked message object is encrypted by the sending message device before sending, and the masked message object is decrypted by the recipient message device after being received.

In some embodiments, revealing at least a part of the message includes touching the touch screen in a region associated with the part of the message to be revealed.

In some embodiments, this method further includes: deleting at least a part of the displayed message by touching the touchscreen in a region associated with the part of the message to be deleted.

In some embodiments, touching the touchscreen includes horizontally swiping the touch screen in a region associated with the message to be revealed.

In some embodiments, the message masking function includes performing at least one of the functions selected from the group consisting of: blurring, redacting, replacing characters, coloring, jumbling, animating, picture replacement, replacing the masked message object with another object.

In some embodiments, the display masking function includes: redacting at least part of the message.

In some embodiments, generating a message on a sending messaging device includes: determining a length of time after receipt before the masked message object will be deleted from the recipient messaging device.

In some embodiments, the recipient device receives a plurality of masked message objects, at least some being displayed such that the messages are unreadable, and wherein a recipient previews the masked message objects by revealing headings or key words of the messages by touching the touchscreen of the recipient message device.

In some embodiments, touching the touchscreen includes vertically swiping the touch screen in a region associated with the displayed masked message objects.

In some embodiments, the headings or keywords are displayed sequentially.

### BRIEF DESCRIPTION OF THE DRAWINGS

The invention will be more fully understood by reference to the Detailed Description, in conjunction with the following figures, wherein:

FIG. 1 shows a system of the invention for selectively concealed mobile messaging from a sending user to a receiving user.

FIGS. 2A and 2B show a concealed text message being revealed using a touch screen in a preferred embodiment.

FIGS. 3A and 3B show a concealed text message being deleted using a touch screen in a preferred embodiment.

FIGS. 4A and 4B show a plurality of concealed text messages being previewed using a touch screen in a preferred embodiment.

FIG. 5 shows a flow diagram of steps for sending and receiving text messages using a message masking function to create and delete a masked message object according to the invention.

FIG. 6 is a process flow diagram showing how message text is transmitted as a masked message object which can be unmasked and then read by a recipient.

FIG. 7 is a process flow diagram showing how message text is transmitted as an encrypted masked message object which can be decrypted and then unmasked and read by a recipient.

FIG. 8 is a process flow diagram showing how message text is transmitted, and then followed by a sender-controlled message change via transmission of a message update object which can be used to update the message before being unmasked and read by a recipient.

FIG. 9 is a process flow diagram showing how message text is transmitted, and then followed by a sender-controlled message delete operation via transmission of a message update object which can be used to delete the message before being unmasked and read by a recipient.

FIG. 10 is a block diagram of a message object of the invention.

### DETAILED DESCRIPTION

The preferred embodiments of the present invention will now be described with reference to the drawings. Identical elements in the various figures are identified with the same reference numerals.

Various embodiments of the present invention are described in detail. Such embodiments are provided by way of explanation of the present invention, which is not intended to be limited thereto. In fact, those of ordinary skill in the art may appreciate upon reading the present specification and viewing the present drawings that various modifications and variations can be made thereto.

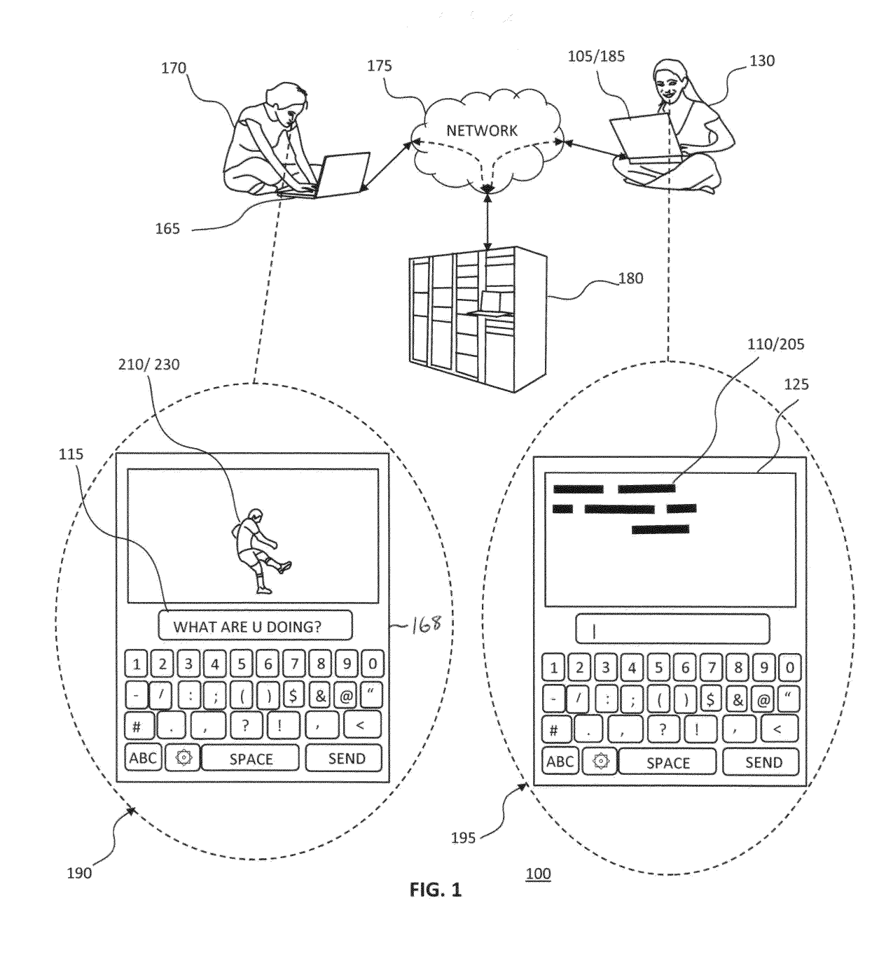

FIG. 1 shows a system for concealed and selectively revealed text, image, and/or video messaging of the present invention.

In a preferred embodiment, using a mobile device 165 (e.g., tablet, laptop, notebook, phablet, or smartphone) having a touch screen 168, a sender 170 can compose a text message 115, or an image 210, or a video 230 on their mobile device 165. As seen in the sender's view 190, the text message 115 is a plainly readable text message. Similarly, the image 210 or the video 230 are clearly visible on the display of the first mobile device 165.

The sender 170 then sends the message, image, or video to a recipient 130. Before sending the message, image, or video, a software module operative on the first mobile device 165 creates a masked message object 110. The masked message object 110 can, for example, be created by augmenting the text message 115 using a message masking function that renders the text message unreadable or unintelligible. Alternately, the masked message object 110 can be created by augmenting the image 210, or the video 230, and produce a generic blocked indicator 205.

When the recipient's 130 mobile device 105 receives the masked message object 110 and displays it on an associated touch display 125, the message is unreadable by the recipient 130, as illustrated in the recipient's view 195. When the masked message object 110 contains an image or a video, the generic blocked indicator 205 may also include one or more indicia indicating that an image or a video is contained in the blocked text. The indicia may, for instance, distinguish between there being an image or a video. The indicia may also, or instead, indicate the file type of the included image or video, i.e., is it a file type such as, but not limited to, a jpeg, an mpeg, a tiff, or some other file type.

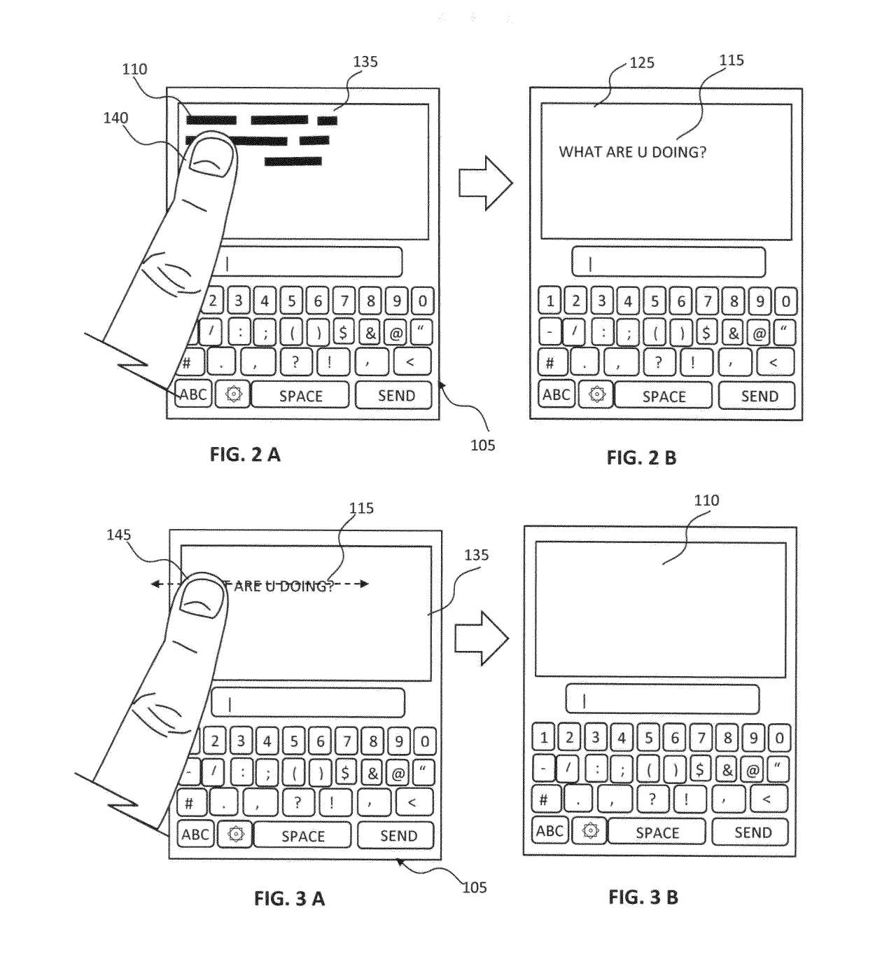

FIGS. 2A and 2B show a schematic view of a concealed text or image message 110 being revealed using a swipe of a finger 140 in a preferred embodiment of the present invention. The recipient 130 may, for instance, reveal all or part of the text message, the image, or the video by physically interacting with said communications device or the associated display, such as by touching the screen, sweeping over the screen, or using a stylus that either contacts the screen during movement, or hovers over the screen that can detect such movement without contact. This interaction may, for instance, be via a touch screen 135, or a touch screen that can detect movement in close proximity over the touch screen, using a stylus or a finger.

In a preferred embodiment, the recipient 130 can, for instance, touch the touch screen 135 in a vicinity of the region in which the masked message object 110 is being displayed to reveal the entire text message, i.e., make the text message portion of the masked message object 110 readable.

Touching the touch screen 135 may, for instance, activate a software module operative on the recipient's messaging device 105 to reverse the masking of all or part of the masked message object 110, thereby allowing the original text message 115 to be displayed on the display 125 in a readable form.

The message 115 may be displayed in its entirety, or it may be displayed a part at a time. In one embodiment, for instance, the message 115 may be displayed a word at a time, so that only one word is visible at any one time, and a sentence of the message appears word by word in sequential order. The rate and duration for which each word appears can be adjusted by the user to suit their reading style. The rate and duration of display can also, or instead, depend in part on the length of each word, with longer words being displayed for a longer time so as to give the viewer more time to absorb the more complex word.

In a further embodiment, the message can be displayed a sentence at a time. This may, for instance, be useful when displaying a longer message.

The augmentation (masking) process may include a step of “visual encryption”, which is NOT encryption, but changes the coarse level appearance of a message so as to remove spatial clues as to its meaning. In this step, the original message may first be scrambled, hashed, or otherwise transformed before being redacted. In this way, the outline or structure of the redacted message may bear little or no resemblance to the outline or structure of the original message, adding a further layer of privacy to the method.

If the indicia displayed with the generic mask indicator show that it contains an image or video, the image or the first frame of the video can be revealed by touching the screen. The image can, for instance, be initially displayed as a small thumbnail image, that can grow in size the longer the screen is touched. There can be an indicator that starts off one color, but at a certain point changes color. If the touch is stopped before the color changes, the display can revert to being the generic mask indicator. If the touch is stopped after the color change, the image can immediately be displayed full-size and, if it is a video rather than simply a single image, the video can begin playing.

Alternately the image or first frame of a video can be revealed by growing it a line at a time in a manner similar to a screen been drawn down or across. The reveal may progress in the manner of a blank screen changing to an image in any of the well-known transitions used in changing between video clips such as, but not limited to, a dissolve, a wipe, a fade-in, or some combination thereof.

The revealing of an image or video can also be done by a swipe of a finger that can, for instance, be a vertical swipe in a downward direction. The color-changing indicator can, in such an instance, depend on how far the swipe has progressed down the screen.

In a further embodiment of the invention, the system can respond to a double tab of the screen by revealing all masked text messages and images.

In yet a further embodiment, the revealed text, image, or video can only be displayed as long as an interaction with the messaging device is maintained. The revealed image or text can, for instance, continue to be displayed—or the video played—as long as the touch screen is pressed by a finger, but may revert to the display showing the masked message or the generic masked message indicator as soon as the finger is no longer touching the touchscreen.

FIGS. 3A and 3B show a revealed and read text message being deleted in a preferred embodiment of the present invention.

Having read the text message, seen the image, or viewed the video, the recipient 130 may want to delete the message. This can be accomplished by touching the messaging device 105.

FIGS. 3A and 3B shows a preferred embodiment where the recipient 130 horizontally swipes 145 the touch screen in a region associated with the displayed masked message object 115, which has the effect of deleting that entire masked message object. This horizontal swipe motion 145 of the finger across the touchscreen, can, for instance, be in either direction, i.e., left to right, or right to left, the motion activating a software module operative on the messaging device 105 to initiate the deletion.

In a preferred embodiment, the deletion initiated by such a motion of the finger is a “universal deletion”, i.e., all instances of the text message, image, video masked message object, wherever they are on the messaging system, are deleted. In the instance where a sender's communication device is not currently connected, a message may be stored on a server such that a next time the sender connects to the network, the communication, or a selected part of it, is deleted. The person making the deletion would be informed that the attempt at deletion did not occur immediately on the sender's device, and may receive a further notification when the deletion has been effected on the sender's device.

In a further preferred embodiment of the invention, the deletion may require that all memories in which the text message, image, video or the masked message object associated with it, may be or may have been stored, are over-written with random or quasi-random data.

In a further embodiment of the invention, the message is deleted a portion at a time.

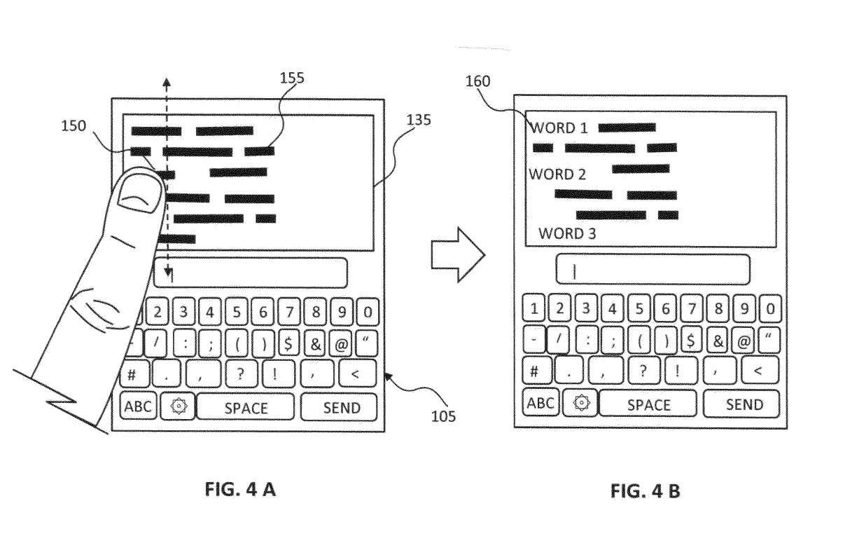

FIGS. 4A and 4B show a plurality of masked text communications being previewed in a preferred embodiment of the present invention.

Having received a number of masked text objects 155, the recipient 130 may want to scan through them to see which to address. Rather than open all the masked text objects, or step through opening them one by one, the recipient 130 may preview the text messages by selectively touching the touchscreen 135 of the messaging device 105.

In a preferred embodiment, the recipient 130 may vertically swipe 150 the touch screen 135 in a region associated with the masked text messages 155. This vertical swipe 150 may, for instance, activate a software module operative on the messaging device 105 to display headings or key words from each of the masked text messages. As shown in FIG. 4B, these headings or keywords 160 can all be displayed at the same time, or they can be displayed in sequence so only one of them is readable at any one time. The headings or keywords 160 can be displayed for a limited amount of time, e.g., for a few seconds, which is typically enough time to read them.

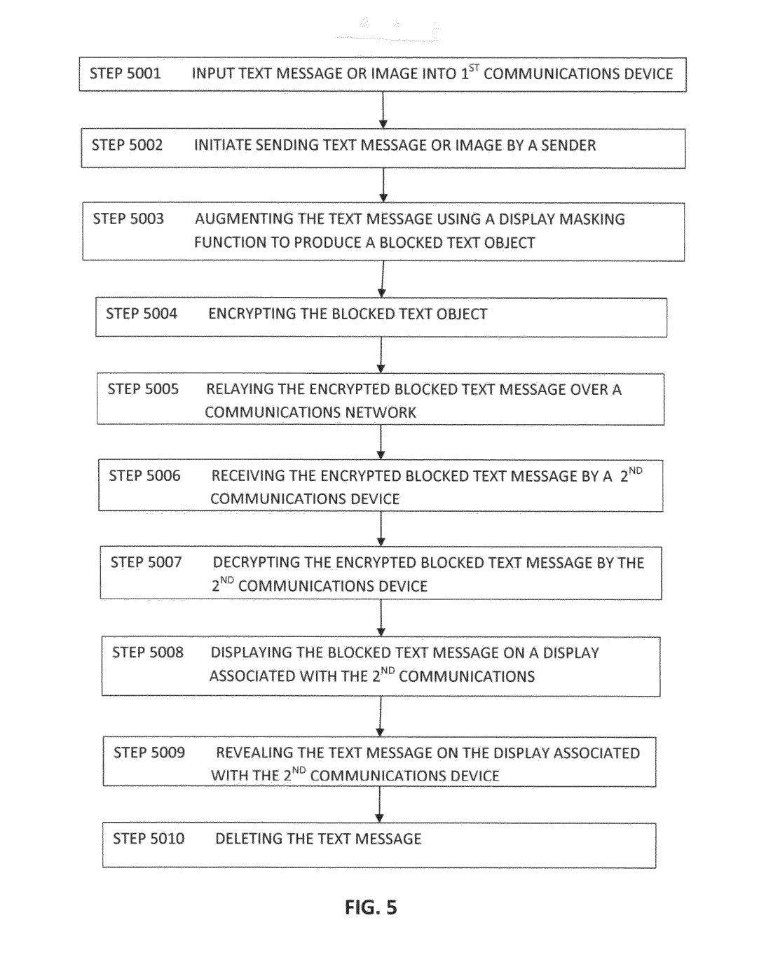

FIG. 5 is a flow diagram of certain steps in the implementation of a preferred embodiment of the present invention.

Step 5001: Input Text Message or image or video into 1st Communications Device (e.g., a mobile messaging device, such as a smart phone, phablet, or tablet computer). In this step, a sender enters a text message, an image, or a video into a communications (mobile messaging) device in any of the well-known methods of performing such functions, and may addresses the text message, image, and/or video to one or more pre-selected, intended recipients.

Step 5002: Initiate Sending the Text Message by the Sender. In this step, having composed a text message, an image, or a video, the sender sends it to one or more recipients. This can, for example, be accomplished by entering mobile messaging device addresses of one or more intended recipients. The sender may then, for example, press a “send” button that initiates sending of the message to the intended recipients.

Step 5003: Augmenting the Text Message using a Message Masking Function to Produce a Masked Message Object.

Prior to actually transmitting the text message, a software module that is activated by the signal to send the text message will, before sending the text message, mask the text message to produce masked message object, that, when initially displayed, will be unintelligible or unreadable. The masking of the text message can be done by a number of functions such as, but not limited to, blurring the text, redacting the text, replacing characters in the text with other characters that are randomly chosen or are from different alphabets than the original text, coloring the text so that it matches and is therefore indistinguishable from the background of the text, jumbling the characters in the text so that the message is garbled and unintelligible, animating the characters of the text so that their constant motion renders them unintelligible, or picture replacement, i.e., replacing one or more characters with a block of pixels that may represent an image or a portion of an image, or some combination thereof, or replacing the entire message object with another object.

In a preferred embodiment, the message masking function produces a masked message object in which the text message is redacted, i.e., all or some of the words or characters in the original text message are made to appear as if hidden by a solid block of color that may typically be, but is not necessarily, black.

In a preferred embodiment, the color of the masking function can, for example, uniquely identify participants in a chat environment, or identify them as belonging to one or more groupings such as, but not limited to, companies, departments, ranks, geographical locations, or some combination thereof. Selective masking can also be implemented, i.e., masking only messages from one or more specified participants. Alternatively, inputs identified by masking color, can be blocked or masked.

Step 5004: Encrypting the Masked Message Object. Prior to sending or transmitting the masked message object, it may optionally be encrypted. The encryption can use any of the well-known public/private key combinations.

Step 5005 Relaying the Encrypted Masked Message over a Communications Network. In this step, the masked message object is transmitted from the sender to one or more recipients using a well-known digital communications network 175 such as, but not limited to, the Internet, a Local Area network, a digital telephone network, a wireless network, a fiber optic network, a cable television network, or some combination thereof. The transmission may be direct from sender to receiver or it may be mediated by one or more communications servers 180.

Step 5006: Receiving the Encrypted Masked Message Object by a 2nd Communications (mobile messaging) Device. In this step, a recipient's 130 communications device 105 receives the masked message object 110 in encrypted form.

Step 5007: Decrypting the Encrypted Masked Message Object by the 2nd Communications (mobile messaging) Device. The masked message object is automatically decrypted by a software module operative on the second communications (mobile messaging) device 185 when a request is entered to display the masked message object 110. The decryption can use well-known public or private decryption algorithms and technology.

Step 5008: Displaying the Masked Message Object on a Display Associated with the 2^{nd} Communications (mobile messaging) Device. The decrypted masked message object 110 is displayed on the display 125 associated with the second communications (mobile messaging) device 185. In this form, the masked message object 110 is unreadable or unintelligible.

Step 5009: Revealing the Text Message on the Display Associated with the 2nd Communications (mobile messaging) Device. To read the text message associated with the masked message object 110, the recipient 130 must interact with the second communications (mobile messaging) device 185. In a preferred embodiment, the interaction may include the recipient 130 touching 140 the touch screen 135 associated with the communications (mobile messaging) device 105 in a region associated with the displayed masked message object. This touch may, for instance, initiate a software module operable on the communications (mobile messaging) device 105 to automatically reverse the effect of the display masking function 120 that was used in the masking of the text message. This can involve one of a number of operations such as, but not limited to, de-blurring the text, un-redacting the text, undoing random replacement of characters in the text with other characters, un-coloring the text so that it contrasts with the background of the text, un-jumbling the characters in the text so that the message is clear, stopping any animation of the characters of the text, replacing blocks of pixels that represent an image or a portion of an image with the originally intended character, replacing the entire masked message object with another object, or some combination thereof.

Step 5010: Deleting the Text Message. Having read or otherwise dealt with the text message, the recipient 130 may want to delete the text message and the associated masked message object. This may be accomplished by a further interaction of the recipient 130 with the communications (mobile messaging) device 105. In a preferred embodiment of the present invention, this interaction includes the recipient 130 horizontally swiping 145 the touch screen 135 associated with the display of the communications (mobile messaging) device in a region associated with the displayed masked message object, or the associated displayed text message 115 that requires deleting.

In a further preferred embodiment of the invention, the sender of the message can set a time when the text message and the associated masked message object is to be deleted from the system. This time can be an interval of time after the message is sent, after the message is received, or after the message is first opened. The deletion can be a “universal deletion” in which all instances of the message and the associated masked message object are removed from the system, as well as from both the sender's and the receiver's communication (mobile messaging) devices.

In a preferred embodiment of the invention, a user can be prevented from taking a screen shot of any revealed communication. Software operative on the communications device can, for example, intercept a command to initiate a screen shot and revert the display to the masked state before allowing the screen shot to occur or, alternatively, add a masking mechanism to the screen so that no intelligible image can be captured. For example, the screen goes black or there is some form of masking the screen. The display can also or instead be masked by, for instance, by causing the screen to display a pattern or a solid color, such as an all-black screen. The communications (mobile messaging) device can also send a notification that a user attempted to take a screen shot of a display in a revealed condition to either the sender of the masked message text or to a server managing the flow of masked message texts. Attempting to take screen shots of a display in a revealed state can result in a warning being sent to the user, or can result in temporary or permanent banning from the service after a certain number of attempts.

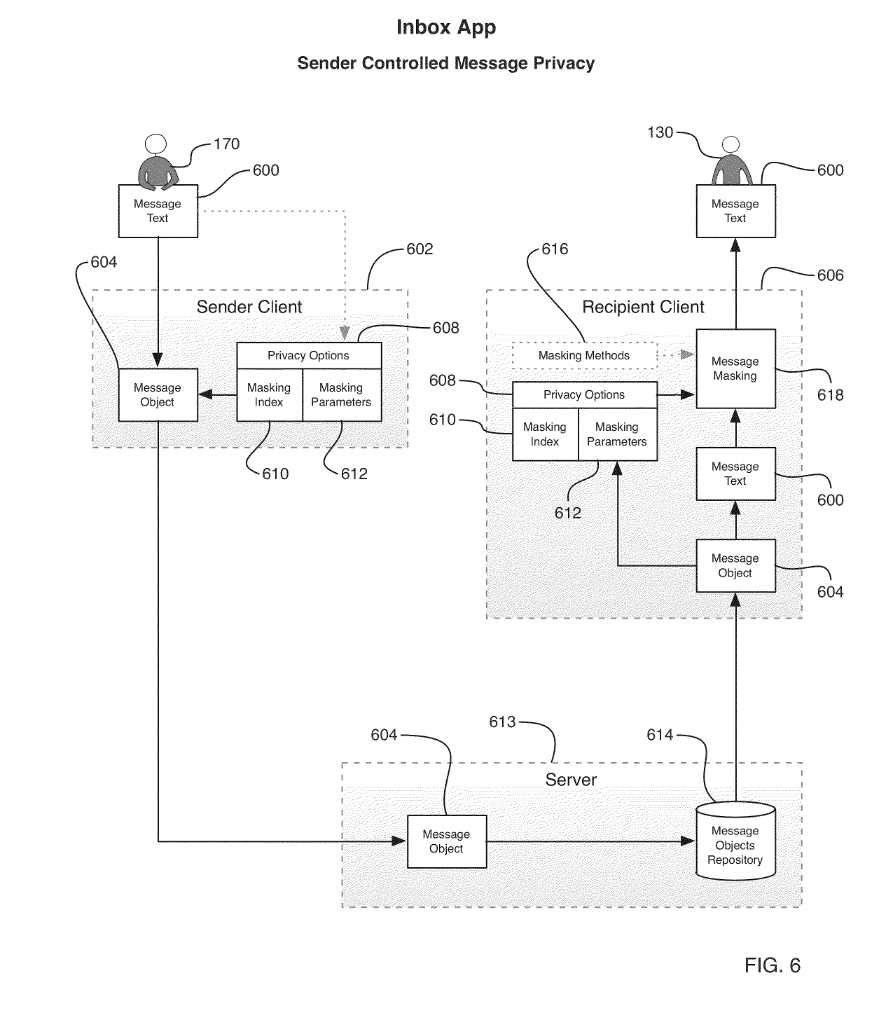

FIG. 6 is a process flow diagram showing how message text 600 is transmitted by sender 170 using a sender client 602 so as to provide a masked message object 604, which can be unmasked and then read using a recipient client 606 so as to provide the message text 600, which can be selectively unmasked by a recipient 130.

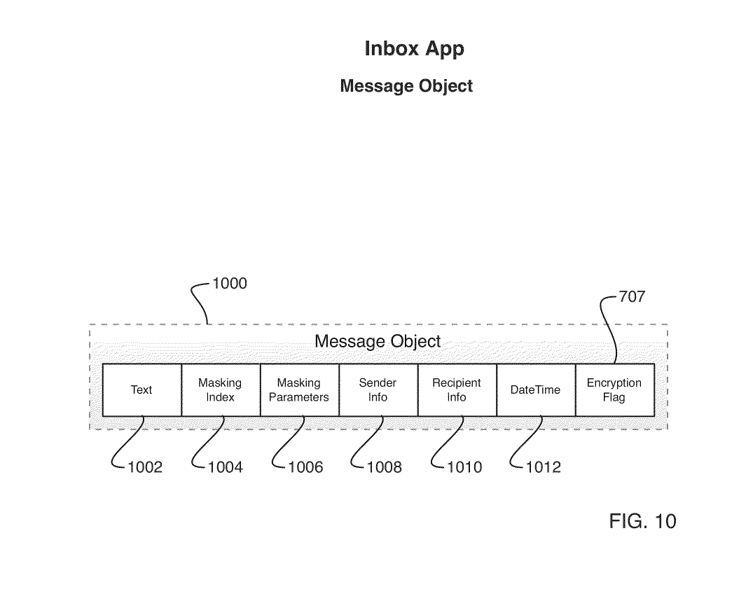

The user 170 sets the privacy options 608, which includes the masking index 610 and the masking parameters 612. For example, masking index 1 could mean “mask message by displaying all characters as black boxes”. Masking index 2 could mean “mask message by setting text color to be identical to the background, thus rendering text practically invisible.” Masking parameter 1 could mean “unmask the entire message as a whole”. Masking parameter 2 could mean “unmask only in the vicinity of where the reader touches the screen”. These are included in the masked message object 604, as shown in FIG. 10, further explained below.

The masked message object 604 is transmitted via a wireless communication network to a server 613 having a message objects repository 614. The masked message object 604 is stored in the message objects repository 614, and is then transmitted to a recipient client 606. The recipient 130 can then selectively access the masked message text 600 incorporated in the masked message object 604 by using the masking index 610 to choose a masking method from a plurality of masking methods 616, and by applying such masking method according to masking parameters 612 of the privacy options 608, so as to provide message masking 618 (e.g., as shown in FIG. 1) that obscures the message text 600. The recipient 130 touches the touch screen display to selectively and privately reveal the message text 600, as explained above.

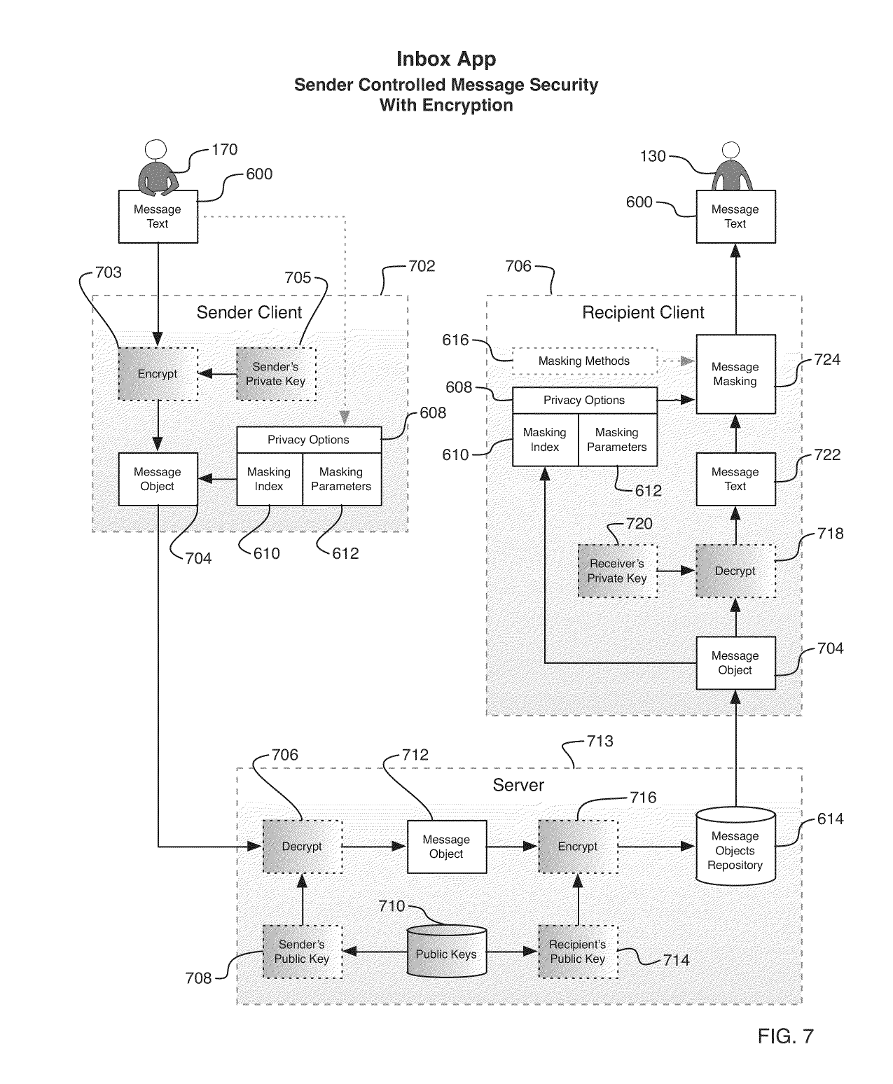

FIG. 7 is a process flow diagram showing how message text 600 is transmitted by sender 170 using an encrypting sender client 702 so as to provide an encrypted masked message object 704, which can be decrypted and then unmasked and read using a decrypting recipient client 706 so as to provide the message text 600, which can be selectively unmasked and read by a recipient 130.

Within the sender client 702, the message text 600 is encrypted 703 using the sender's private key 705. Accordingly, an encryption flag 707 of the message object 704 (also shown in FIG. 10 in further detail) is set.

The user 170 sets the privacy options 608, which includes the masking index 610 and the masking parameters 612. These are included in the encrypted masked message object 704, as shown in FIG. 10, further explained below.

The encrypted and masked message object 704 is transmitted via a wireless communication network to a server 713 having a message objects repository 614. The encrypted masked message object is first decrypted 706 using the sender's public key 708 which is stored in a repository of public keys 710, so as to provide a decrypted message object 712. The decrypted message object is then encrypted 716 using the recipient's public key 714 so as to provide an encrypted masked message object to be stored in the message object repository 614. The encrypted masked message object 704 is then transmitted to a recipient client 706.

At the recipient client 706, the text of the encrypted masked message object 704 is first decrypted 718 using the receiver's private key 720, so as to provide a decrypted masked message object having decrypted message text 722. The decrypted message text 722 is provided with message masking 724 using the masking index 610 and the masking parameters 612 of the privacy options 608.

The recipient 130 can then selectively access the masked message text 600 incorporated in the encrypted masked message object 704 by application of masking methods 616 to the masked message object so as to provide message masking 724 (e.g., as shown in FIG. 1) that obscures the message text 600. The recipient 130 touches the touch screen display to selectively and privately reveal the message text 600, as explained above.

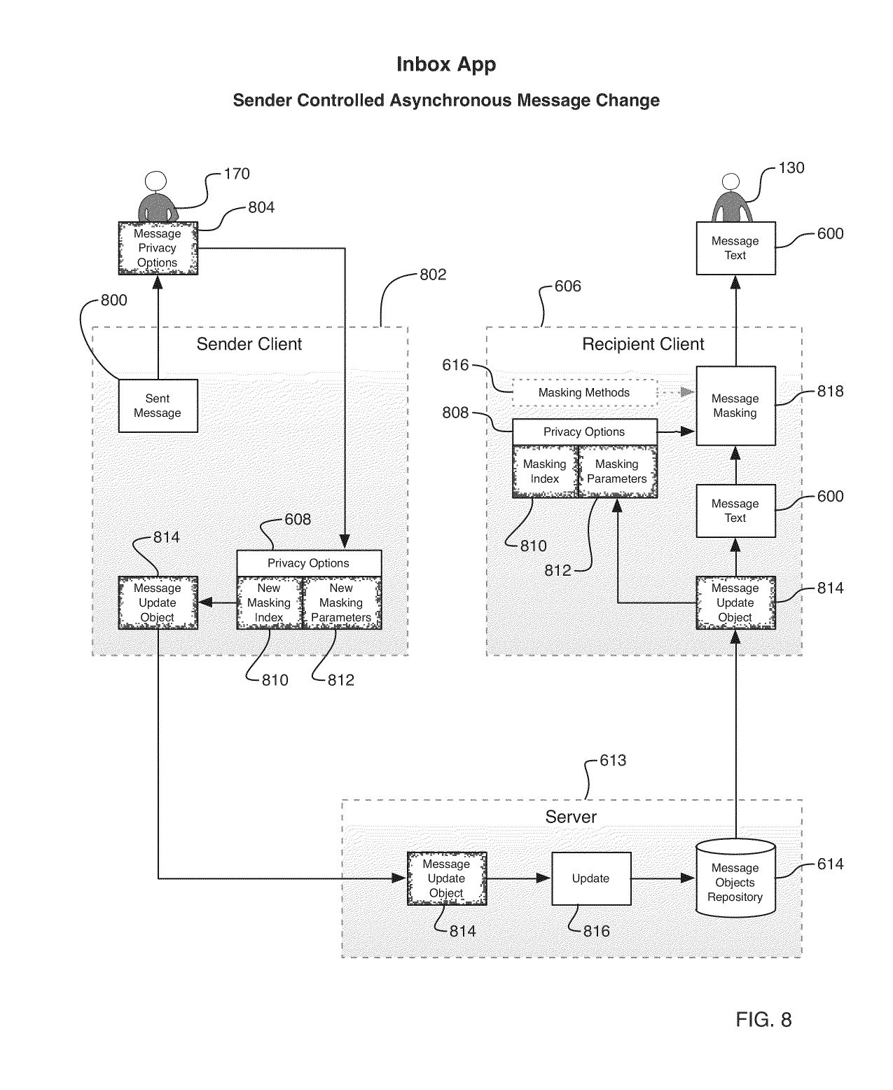

With reference to FIG. 8, after a sender 170 has transmitted a sent message 800 the sender 170 can modify 804 the message privacy options 608 so as to create a new masking index 810 and new masking parameters 812. The new masking index 810 and the new masking parameters are incorporated into a message update object 814. The message update object 814 is transmitted to the server 613, which in turn updates 816 a masked message object in the message objects repository 614.

The server 613 then transmits the message update object 814 to the recipient client 606, whereupon the new masking index 810 and the new masking parameters 812 of the message update object 814 become the new privacy options 608.

The recipient 130 can then selectively access the masked message text 600 incorporated in the masked message object by application of masking methods 616 to the masked message object so as to provide message masking 818 (e.g., as shown in FIG. 1) that obscures the message text 600. The recipient 130 touches the touch screen display to selectively and privately reveal the message text 600 in accordance with the message masking 818, as explained above.

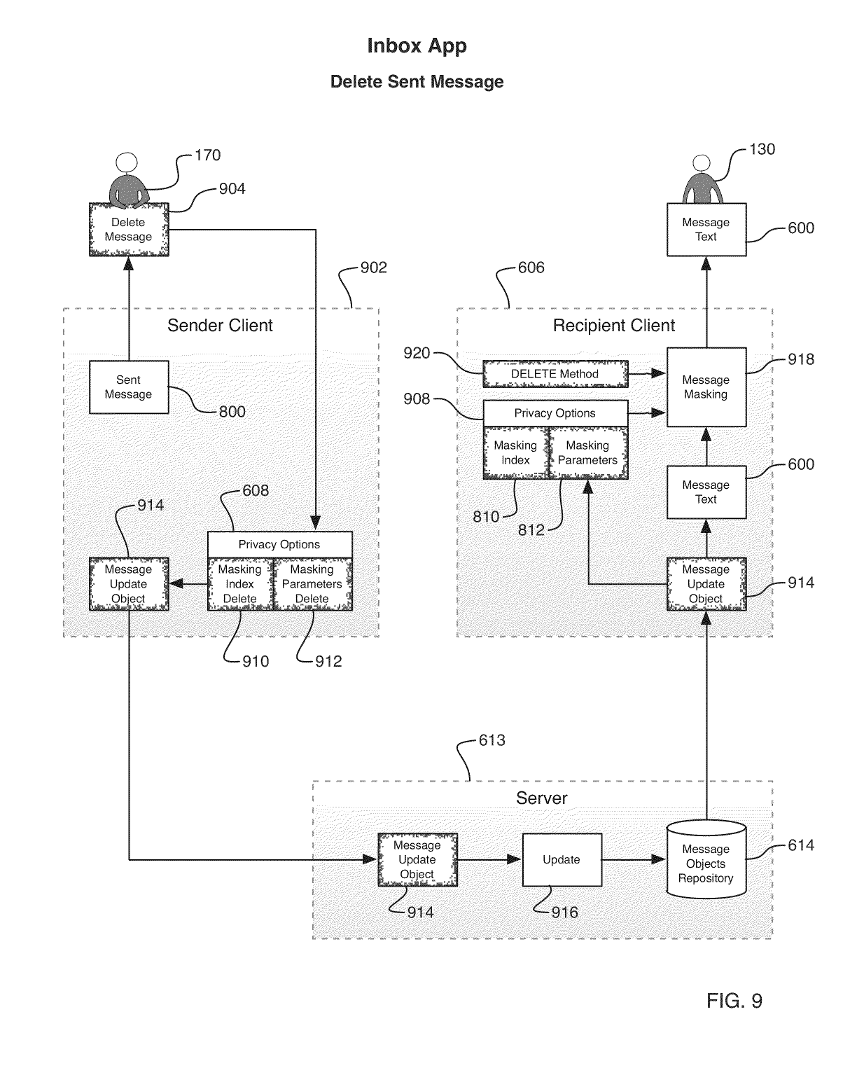

With reference to FIG. 9, after a sender 170 has transmitted a sent message 800 the sender 170 can delete 904 the message 800 by changing the privacy options 608 to become masking index of delete 910 and masking parameters of delete 912. The masking index of delete 910 and new masking parameters of delete 912 instructions are incorporated into a message update object 914.

The message update object 914 is transmitted to the server 613, which in turn updates 916 a masked message object in the message objects repository 614 so as to delete the message text 600 of the respective masked message object stored in the message objects repository 614.

The server 613 then transmits the message update object 914 to the recipient client 606, whereupon new masking index of delete 810 and the masking parameters of delete 912 of the message update object 914 become the new privacy options 608.

The recipient 130 cannot access the masked message text 600 incorporated in the masked message object due to application of the DELETE method 920 to the masked message object so as to provide remote message deletion by the sender 170 of the message text 600 received by the recipient, the masked message object including the message text 600 also having been remotely deleted from the message objects repository 614.

Referring to FIG. 10, a message object 1000 includes message text 1002, a masking index 1004, masking parameters 1006, sender info 1008, recipient info 1010, date/time 1012, and an encryption flag 707.

Other modifications and implementations will occur to those skilled in the art without departing from the spirit and the scope of the invention as claimed. Accordingly, the above description is not intended to limit the invention except as indicated in the following claims.

What is claimed is:

1. A method for providing enhanced message privacy when exchanging messages using a messaging device having a touchscreen, the method comprising:
receiving a masked message object on a messaging device, the masked message object including a message and a message masking function;
displaying the masked message object on the messaging device, the message of the masked message object being unreadable or unviewable due to the message masking function; and
revealing at least a part of the message so that the part of the message becomes readable or viewable in response to a touchscreen of the messaging device being touched.

2. The method of claim 1, wherein revealing at least a part of the message includes:
touching the touchscreen of the messaging device in a region associated with part of the message to be revealed.

3. The method of claim 1, further comprising:
deleting at least a part of the displayed message by touching the touchscreen in a region associated with the part of the message to be deleted.

4. The method of claim 2, wherein touching the touchscreen includes horizontally swiping the touch screen in a region associated with the message to be revealed.

5. The method of claim 4, wherein the message masking function includes a capability of performing at least one of the functions selected from the group consisting of:
blurring, redacting, replacing characters, coloring, jumbling, animating, picture replacement, replacing the masked message object with another object.

6. The method of claim 1, wherein the message can include at least one of:
a text message, an image, a video.

7. A method for providing enhanced message privacy when exchanging messages using a messaging device having a touchscreen, the method comprising:
generating a message on a messaging device;
automatically creating a masked message object including the message and a message masking function; and
sending the masked message object from the messaging device to a recipient messaging device.

8. The method of claim 7, wherein the message masking function includes a capability of performing at least one of the functions selected from the group consisting of:
blurring, redacting, replacing characters, coloring, jumbling, animating, picture replacement.

9. The method of claim 8 wherein the message masking function includes:
redacting at least part of the message.

10. A method for providing enhanced message privacy when exchanging messages using a messaging device having a touchscreen, the method comprising:
generating a message on a sending messaging device;
automatically creating a masked message object including the message and a message masking function;
sending the masked message object from the sending messaging device to a recipient messaging device;
receiving the masked message object on the recipient messaging device, the object including a message and a message masking function;
displaying the masked message object on the recipient messaging device, the message of the masked message object being unreadable or unviewable due to the message masking function; and
revealing at least a part of the message so that the part of the message becomes readable or viewable in response to a touchscreen of the recipient messaging device being touched.

11. The system of claim 10 wherein the masked message object is encrypted by the sending message device before sending, and the masked message object is decrypted by the recipient message device after being received.

12. The method of claim 11, wherein revealing at least a part of the message includes touching the touch screen in a region associated with the part of the message to be revealed.

13. The method of claim 11, further comprising:
deleting at least a part of the displayed message by touching the touchscreen in a region associated with the part of the message to be deleted.

14. The method of claim 12, wherein touching the touchscreen includes horizontally swiping the touch screen in a region associated with the message to be revealed.

15. The method of claim 10 wherein the message masking function includes performing at least one of the functions selected from the group consisting of:
blurring, redacting, replacing characters, coloring, jumbling, animating, picture replacement, replacing the masked message object with another object.

16. The method of claim 15 wherein the display masking function includes:
redacting at least part of the message.

17. The method of claim 10 wherein generating a message on a sending messaging device includes:
determining a length of time after receipt before the masked message object will be deleted from the recipient messaging device.

18. The method of claim 10 wherein the recipient device receives a plurality of masked message objects, at least some being displayed such that the messages are unreadable, and wherein a recipient previews the masked message objects by revealing headings or key words of the messages by touching the touchscreen of the recipient message device.

19. The method of claim 18 wherein touching the touchscreen includes vertically swiping the touch screen in a region associated with the displayed masked message objects.

20. The method of claim 19 wherein the headings or keywords are displayed sequentially.
